(19) United States
(12) Patent Application Publication
(10) Pub. No.: US 2005/0152007 A1
(43) Pub. Date: Jul. 14, 2005

(54) Scanner and method for scanning an image or images

(76) Inventors: Stephen K. Cunnagin, Lexington, KY (US); Curt P. Breswick, Georgetown, KY (US); Ronald E. Garnett, Lexington, KY (US); David K. Murray, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/754,125

(22) Filed: Jan. 9, 2004

(51) Int. Cl. G06K 9/00

(52) U.S. Cl. 358/474; 382/318

(57) ABSTRACT

A scanner includes a scan bar, a first scan-bar homing reference, a second scan-bar homing reference and an image placement area. The scan bar is movable along a subscan axis. The second scan-bar homing reference is spaced apart along the subscan axis from the first scan-bar homing reference. The image placement area is located between the first and second scan-bar homing references. A broad method uses the scanner. One step includes performing a prescan or an image scan of an image by moving the scan bar along the subscan axis from the first scan-bar homing reference in relation to the image. Another step includes performing a prescan or an image scan of the image or of an additional image by moving the scan bar along the subscan axis from the second scan-bar homing reference in relation to the image or the additional image.

### CROSS REFERENCES TO RELATED APPLICATIONS

None.

### STATEMENT REGARDING FEDERALLY SPONSORED RESEARCH OR DEVELOPMENT

None. REFERENCE TO SEQUENTIAL LISTING, ETC.

None.

### BACKGROUND

1. Field of the Invention

The present invention relates generally to scanners and scanning methods, and more particularly to those having or using a scan-bar homing reference.

2. Description of the Related Art

Scanners are used to scan an image to create a scanned image which can be displayed on a computer monitor, which can be used by a computer program, which can be printed, which can be faxed, etc. One conventional method for scanning an image uses a scanner having a subscan axis, a scan bar having sensor elements, and a scan-bar homing reference. The scan bar starts out at the homing position at the scan-bar homing reference. By having the scan bar be located at the scan-bar homing reference before starting a scan, the scanner is able to establish an accurate position reference for the scan bar each time the scan bar moves from the scan-bar homing reference as well as calibrating the sensor elements to a known white (or other color) surface and optionally to a known black surface before performing a prescan of the image. A prescan of the image is performed by then moving the scan bar along the subscan axis in relation to or over the image over the complete image placement area. The scanner obtains information about the image from the prescan which the scanner uses for the subsequent image scan of the image. Prescan information of the image includes, without limitation, the size of the image (including the length of the image along the subscan axis), whether the image is text or graphics or a combination of both, and whether the image is mono or color. Such prescan information is used, without limitation, to automatically tune the image scan to obtain the best combination of scan speed, scan resolution, print resolution, shingling, filtering, and color tables for the particular image, as is known to those skilled in the art. After the prescan, the scan bar is returned to the scan-bar homing reference to reestablish an accurate position reference for the scan bar. An image scan is performed by then moving the scan bar along the subscan axis in relation to or over the image. After the image scan, the scan bar is returned to the scan-bar homing reference to reestablish an accurate position reference for the scan bar and to await the next image. Another conventional method omits the prescan.

What is needed is an improved scanner and/or an improved method for scanning an image or images.

### SUMMARY OF THE INVENTION

An embodiment of the invention is for a scanner. The scanner includes a scan bar, a first scan-bar homing reference, a second scan-bar homing reference and an image placement area. The scan bar is movable along a subscan axis. The second scan-bar homing reference is spaced apart along the subscan axis from the first scan-bar homing reference. The image placement area is located between the first and second scan-bar homing references. The homing references can be forms by using a geometric shape position switches or optical break sensors. In additional calibration references can also be used for calibrating the scan bar and its elements. The calibration references can be colored and if preferably colored from a group of colors consisting of white, black, gray or combinations of the foregoing colors. The calibration references can be molded into the scan bar, painted onto the scan bar or by labeling the scan bar with the calibration reference.

A broad method of the invention is for scanning an image or images. One step includes obtaining a scanner including a subscan axis, including a scan bar having sensor elements, including a first scan-bar homing reference and including a second scan-bar homing reference spaced apart along the subscan axis from the first scan-bar homing reference. Another step includes performing a prescan or an image scan of an image by moving the scan bar along the subscan axis from the first scan-bar homing reference in relation to the image. An additional step includes performing a prescan or an image scan of the image or of an additional image by moving the scan bar along the subscan axis from the second scan-bar homing reference in relation to the image or the additional image.

Several benefits and advantages are derived from the broad method and/or the embodiment of the invention. A position reference for the scan bar can be established (and optionally the sensor elements of the scan bar can be calibrated) at either of the two scan-bar homing references so that a prescan and/or an image scan can be started from the closer one of the two scan-bar homing references to the position of the scan bar at the completion of its previous scan. In one example, this will cut total scanning time in half.

### BRIEF DESCRIPTION OF THE DRAWINGS

FIG. 1 is a schematic top plan view of a first embodiment of a scanner of the invention.

FIG. 2 is a block diagram of a broad method of the invention which, in one application, is carried out using the scanner of FIG. 1.

### DETAILED DESCRIPTION

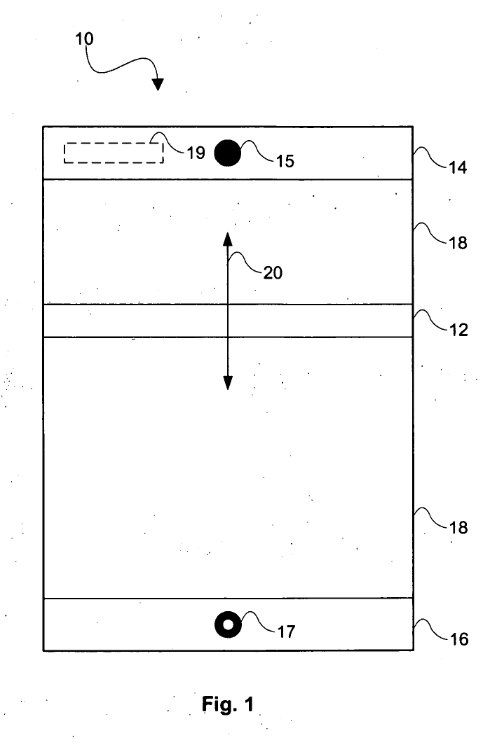

FIG. 1 illustrates a first embodiment of a scanner 10 of the invention. The scanner 10 includes a scan bar 12, a first scan-bar homing reference 14, a second scan-bar homing reference 16 and an image placement area 18. The scan bar 12 is movable along a subscan axis 20. The second scan-bar homing reference 16 is spaced apart along the subscan axis 20 from the first scan-bar homing reference 14. The image placement area 18 is disposed between the first and second scan-bar homing references 14 and 16. The scan bar 12 can be positioned over the image placement area or beneath the image placement area depending on the construction of the scanner. Where the scan bar is positioned below the image placement area, the image placement area is constructed of a transparent material such as glass or plastic.

The scan bar is generally either a CCD (Charge Coupled Device) array or CIS (Contact Image Sensors) array. The CCD array is a collection of tiny, light-sensitive diodes, which convert photons into electrons. These diodes are called photosites—the brighter the light that hits a single photosite, the greater the electrical charge that will accumulate at that site. The image of the document that is scanned using a light source such as a fluorescent bulb reaches the CCD array through a series of mirrors, filters and lenses. The exact configuration of these components will depend on the model of scanner. Some CCD scan bars use a three pass scanning method. Each pass uses a different color filter (red, green or blue) between the lens and CCD array. After the three passes are completed, the scanner software assembles the three filtered images into a single full-color image. Most CCD scanners use the single pass method. The lens splits the image into three smaller versions of the original. Each smaller version passes through a color filter (either red, green or blue) onto a discrete section of the CCD array. The scanner software combines the data from the three parts of the CCD array into a single full-color image.

In general, for inexpensive flatbed scanners contact image sensors (CIS) are used in the scan bar 14. CIS arrays replaces the CCD array, mirrors, filters, lamp and lens with an array of red, green and blue light emitting diodes (LEDs) and a corresponding array of phototransistors. The image sensor array consisting of 600, 1200, 2400 or 4800 LEDs and phototransistors per inch (depending on resolution) spans the width of the scan area and is placed very close to the glass plate upon which rest the image to be scanned. When the image is scanned, the LEDs combine to provide a white light source. The illuminated image is then captured by the row of sensors. CIS scanners are cheaper, lighter and thinner, but may not provide the same level of quality and resolution found in most CCD scanners. Color scanning is done by illuminating each color type of LED separately and then combining the three scans.

In one example, the scan-bar homing reference 14 and 16 includes a scan-* bar homing strip (as shown in FIG. 1) which is an area (whether having the shape of a strip or a non-strip) of the scanner 10 which is adapted to be scanned by the scan bar 12 to establish a position reference for the scan bar 12. In another example, the scan-bar homing reference (not shown) includes an optical break sensor, wherein the scan bar includes a flag (not shown) which is sensed by the optical break sensor. In one variation, the optical break sensor is “U” shaped having a light source on one arm of the “U” aimed at the other arm having a light sensor, wherein, when the scan bar is moved to the optical break sensor, the flag enters the space between the arms blocking the light beam which establishes a position reference for the scan bar. In an additional example, the scan-bar homing reference (not shown) includes a flag, wherein the scan bar includes an optical break sensor. Other forms of positional sensors can also be employed. Other examples are left to the artisan. It is noted that the image placement area 18 is defined as an area of the scanner 10 which is adapted to have an image placed thereon by a user for scanning by the scan bar 12. The image placement area 18 is sometimes referred to as the scanning bed.

In one variation of the scanner 10, the first scan-bar homing reference 14 is a first scan-bar homing and calibration reference and/or the second scan-bar homing reference 18 is a second scan-bar homing and calibration reference. In one example, the first and/or second scan-bar homing reference 14 and/or 16 includes a calibration strip (shown as a dashed rectangle 19). In one variation, the first scan-bar homing reference 14 is a first scan-bar homing and calibration strip and/or the second scan-bar homing reference 16 is a second scan-bar homing and calibration strip. Other examples are left to the artisan. The homing reference can be implemented using a geometric shape, such as without limitation, a solid circle 15, a ring 17, a square, a cross, a triangle (all not shown) or a position switch or a optical break sensor. Preferably, when the scan-bar homing references are geometric shapes, the second scan-bar homing reference varies either in shape, position or number from the first scan-bar homing reference.

Calibration is done to account for manufacturing variations in the scanner, the scan bar and its elements, the light source and for variations in those components as they age during use. The calibration reference can be colored with a variety of colors. The calibration reference is typically implemented using a white area in the scan-bar homing reference combination and is used to perform what is known in the art as a white point calibration of the scanner and its elements. In addition, the calibration reference can further include a black portion that can be used to perform a black point calibration of the scanner and its elements. In prior art machines, black point calibration was accomplished by turning off the light source (i.e., the LEDs in a CIS scanner or the light bulb in a CCD scanner) and then scanning the calibration reference. Combinations of black, white, gray, and other colors can also be used to color the calibration reference. The calibration reference and/or the homing reference can be molded into the scan bar 12, painted on or be in the form of a label. The calibration strip is positioned to be visible to the scan bar 12 and when the homing reference is a geometric shape it is also preferably positioned to be visible to the scanning bar 12.

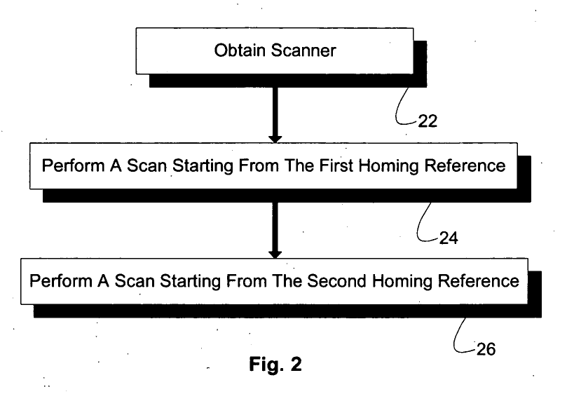

A broad method of the invention is for scanning an image or images and includes steps a) through c). Step a) is labeled as “Obtain Scanner” in block 22 of FIG. 2. Step a) includes obtaining a scanner 10 including a subscan axis 20, including a scan bar 12 having a plurality of sensor elements (not shown in the top view of FIG. 1), including a first scan-bar homing reference 14 and including a second scan-bar homing reference 16 spaced apart along the subscan axis 20 from the first scan-bar homing reference 14. Step b) is labeled as “Perform A Scan Starting From The First Homing Reference” in block 24 of FIG. 2. Step b) includes performing a prescan or an image scan of an image (not shown in FIG. 1) by moving the scan bar 12 along the subscan axis 20 from the first scan-bar homing reference 14 in relation to the image. Step c) is labeled as “Perform A Scan Starting From The Second Homing Reference” in block 26 of FIG. 2. Step c) includes performing a prescan or an image scan of the image or of an additional image by moving the scan bar 12 along the subscan axis 20 from the second scan-bar homing reference 16 in relation to the image or the additional image.

In one example of the broad method, step b) performs a prescan of an image, and step c) performs an image scan of the image. In one enablement of this example, the image is disposed on a sheet of paper having a top and a bottom and the top of the sheet is positioned proximate the first scan-bar homing reference 14, wherein the first scan-bar homing reference 14 corresponds to the start position of the scan bar 12 for beginning a prescan of an image, wherein the prescan of the image is from the top of the sheet to the bottom of the sheet, wherein the image scan of the image is from the bottom of the sheet to the top of the sheet, and wherein the image, if printed, is printed from the bottom up because the bottom of the page is image scanned first and because, for performance reasons, in this example printing is begun just after beginning the image scan. In another enablement of this example, the top of the sheet is positioned proximate the second scan-bar homing reference 16, wherein the first scan-bar homing reference 14 corresponds to the start position of the scan bar 12 for beginning a prescan of an image, wherein the prescan of the image is from the bottom of the sheet to the top of the sheet, wherein the image scan of the image is from the top of the sheet to the bottom of the sheet, and wherein the image, if printed, is printed from the top down (which results in longer scan bar moves for a shorter sheet).

A first more-detailed method of the broad method of the invention is for scanning an image and includes steps a) through c). Step a) includes obtaining a scanner 10 including a subscan axis 20, including a scan bar 12 having a plurality of sensor elements, including a first scan-bar homing reference 14 and a second scan-bar homing reference 16 spaced apart along the subscan axis 20 from the first scan-bar homing reference 14. Step b) includes performing a plurality of prescans of the image by alternately moving the scan bar 12 in relation to or over the image along the subscan axis 20 from the first scan-bar homing reference 14 to the second scan-bar homing reference 16 for each odd numbered prescan of the plurality of prescans and from the second scan-bar homing reference 16 to the first scan-bar homing reference 14 for each even numbered prescan of the plurality of prescans. Step c) includes, after step b), image scanning the image by moving the scan bar 12 in relation to the image along the subscan axis 20.

In one implementation of the first more-detailed method, there is also included the step of establishing a position reference for the scan bar 12 each time before the scan bar is moved from each of the first and second scan-bar homing references 14 and 16. In one variation, the first scan-bar homing reference 14 is a first scan-bar homing and sensor-element calibration reference. In this variation, there is also included, before step b), the step of calibrating the plurality of sensor elements from a scan of the first scan-bar homing reference 14 by the scan bar 12. In the same or another implementation, there is also included, after step c), the step of moving the scan bar 12 along the subscan axis 20 to the closer of the first and second scan-bar homing references 14 and 16. In one application, the scanner 10 is a component of a printing system. In one variation, the printing system is a computer printer, a host-based or stand-alone copier, or a host-based or stand-alone all-in-one machine which copies, prints, faxes, etc.

A second more-detailed method of the broad method of the invention is for scanning an image and includes steps a) through d). Step a) includes obtaining a scanner 10 including a subscan axis 20, including a scan bar 12 having a plurality of sensor elements, including a first scan-bar homing reference 14 and including a second scan-bar homing reference 16 spaced apart along the subscan axis 20 from the first scan-bar homing reference 14. Step b) includes disposing the scan bar 12 about the first scan-bar homing reference 14. Step c) includes, after step b), performing a first prescan of the image by moving the scan bar 12 from the first scan-bar homing reference 14 to the second scan-bar homing reference 16 in relation to the image along the subscan axis 20. Step d) includes, after step c), performing a second prescan of the image by moving the scan bar 12 from the second scan-bar homing reference 16 to the first scan-bar homing reference 14 in relation to the image along the subscan axis 20.

In one implementation of the second more-detailed method, there is also included the step of establishing a position reference for the scan bar 12 each time before the scan bar is moved from each of the first and second scan-bar homing references 14 and 16. In one variation, the first scan-bar homing reference 14 is a first scan-bar homing and sensor-element calibration reference. In this variation, there is also included, between steps b) and c), the step of calibrating the plurality of sensor elements from a scan of the first scan-bar homing reference 14 by the scan bar 12. In one application, the scanner 10 is a component of a printing system.

A third more-detailed method of the broad method of the invention is for scanning images and includes steps a) through g). Step a) includes obtaining a scanner 10 including a subscan axis 20, including a scan bar 12 having a plurality of sensor elements, including a first scan-bar homing reference 14 and including a second scan-bar homing reference 16 spaced apart along the subscan axis 20 from the first scan-bar homing reference 14. Step b) includes disposing the scan bar 12 about the first scan-bar homing reference 14. Step c) includes prescanning a first image by moving the scan bar 12 from the first scan-bar homing reference 14 to the second scan-bar homing reference 16 in relation to the image along the subscan axis 20. Step d) includes, after step c), image scanning the first image by moving the scan bar 12 from the second scan-bar homing reference 16 toward the first scan-bar homing reference 14 in relation to the image along the subscan axis 20. Step e) includes, after step d), moving the scan bar 12 to the second scan-bar homing reference 16, wherein the second scan-bar homing reference 16 is the closer of the first and second scan-bar homing references 14 and 16 to the scan bar 12 at the completion of step d). Step f) includes, after step e), prescanning a second image, which is different from the first image, by moving the scan bar 12 from the second scan-bar homing reference 16 to the first scan-bar homing reference 14 in relation to the image along the subscan axis 20. Step g) includes, after step f), image scanning the second image by moving the scan bar 12 from the first scan-bar homing reference 14 toward the second scan-bar homing reference 16 in relation to the image along the subscan axis 20.

In one implementation of the third more-detailed method, there is also included the step of establishing a position reference for the scan bar 12 each time before the scan bar is moved from each of the first and second scan-bar homing references 14 and 16. In one variation, the first scan-bar homing reference 14 is a first scan-bar homing and sensor-element calibration reference. In this variation, there is also included, between steps b) and c), the step of calibrating the plurality of sensor elements from a scan of the first scan-bar homing reference 14 by the scan bar 12. In one modification, the second scan-bar homing reference 16 is a second scan-bar homing and sensor-element calibration reference. In this modification, there is also included, between steps e) and f), the step of calibrating the plurality of sensor elements from a scan of the second scan-bar homing reference 16 by the scan bar 12. In one application, the scanner 10 is a component of a printing system.

A fourth more-detailed method of the broad method of the invention is for scanning images and includes steps a) through e). Step a) includes obtaining a scanner 10 including a subscan axis 20, including a scan bar 12 having a plurality of sensor elements, including a first scan-bar homing reference 14 and including a second scan-bar homing reference 16 spaced apart along the subscan axis 20 from the first scan-bar homing reference 14. Step b) includes establishing a position reference for the scan bar 12 including disposing the scan bar about or over the first scan-bar homing reference 14. Step c) includes, after step b), image scanning the first image by moving the scan bar 12 from the first scan-bar homing reference 14 toward the second scan-bar homing reference 16 in relation to the image along the subscan axis 20. Step d) includes, after step c), establishing an updated position reference for the scan bar 12 including disposing the scan bar 12 about or over the second scan-bar homing reference 16. Step e) includes, after step d), image scanning a second image, which is different from the first image, by moving the scan bar 12 from the second scan-bar homing reference 16 toward the first scan-bar homing reference 14 in relation to the image along the subscan axis 20. In one application, no prescans are performed.

In one implementation of the fourth more-detailed method, the first scan-bar homing reference 14 is a first scan-bar homing and sensor-element-calibration reference and/or the second scan-bar homing reference 16 is a second scan-bar homing and sensor-element-calibration reference. In this implementation, there is also included, between steps b) and c), the step of calibrating the plurality of sensor elements from a scan of the first scan-bar homing reference 14 by the scan bar 12 and/or, between steps d) and e), the step of calibrating the plurality of sensor elements from a scan of the second scan-bar homing reference 16 by the scan bar 12.

A fifth more-detailed method of the broad method of the invention is for scanning and printing an image and includes steps a) through g). Step a) includes obtaining a scanner 10 including a subscan axis 20, including a scan bar 12 having a plurality of sensor elements, including a first scan-bar homing reference 14 and including a second scan-bar homing reference 16 spaced apart along the subscan axis 20 from the first scan-bar homing reference 14. Step b) includes establishing a position reference for the scan bar 12 including disposing the scan bar 12 about or over the first scan-bar homing reference 14. Step c) includes, after step b), performing a first image scan of the image by moving the scan bar from the first scan-bar homing reference 14 toward the second scan-bar homing reference 16 in relation to the image along the subscan axis 20. Step d) includes, after step c), printing a copy of the first image scan of the image. Step e) includes, after step d), establishing an updated position reference for the scan bar 12 including disposing the scan bar 12 about the second scan-bar homing reference 16. Step f) includes, after step e), performing a second image scan of the image by moving the scan bar 12 from the second scan-bar homing reference 16 toward the first scan-bar homing reference 14 in relation to the image along the subscan axis 20. Step g) includes, after step f), printing a copy of the second image scan of the image. In one application, no prescans are performed.

In one implementation of the fifth more-detailed method, the first scan-bar homing reference 14 is a first scan-bar homing and sensor-element-calibration reference. In this implementation, there is also included, between steps b) and c), the step of calibrating the plurality of sensor elements from a scan of the first scan-bar homing reference 14 by the scan bar 12.

Several benefits and advantages are derived from the broad method and/or the embodiment of the invention. A position reference for the scan bar can be established (and optionally the sensor elements of the scan bar can be calibrated) at either of the two scan-bar homing references so that a prescan and/or an image scan can be started from the closer one of the two scan-bar homing references to the position of the scan bar at the completion of its previous scan. In one example, this will cut total scanning time in half.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

1. A scanner comprising:
a) a scan bar movable along a subscan axis;
b) a first scan-bar homing reference;
c) a second scan-bar homing reference spaced apart along the subscan axis from the first scan-bar homing reference; and
d) an image placement area disposed between the first and second scan-bar homing references.

2. The scanner of claim 1 wherein the first scan-bar homing reference is a first scan-bar homing and calibration reference and/or the second scan-bar homing reference is a second scan-bar homing and calibration reference.

3. The scanner of claim 2 wherein the each of the calibration references is colored.

4. The scanner of claim 3 wherein the color is selected from a group consisting of white, black, gray and a combination of the foregoing colors.

5. The scanner of claim 1 wherein the first scan-bar homing reference and the second scan-bar homing reference are each further comprised of a geometric shape.

6. The scanner of claim 5 wherein the first scan-bar homing reference and the second scan-bar homing reference are different from one another.

7. The scanner of claim 5 wherein each of first and second scan-bar homing references are positioned on the scanner by use one of a group consisting of molding, painting, and labeling.

8. The scanner of claim 1 wherein the first scan-bar homing reference and the second scan-bar homing reference are each further comprised of a position switch.

9. The scanner of claim 8 wherein the position switch comprises an optical break sensor.

10. A method of scanning an image or images comprising:
a) obtaining a scanner including a subscan axis, including a scan bar having a plurality of sensor elements, including a first scan-bar homing reference and including a second scan-bar homing reference spaced apart along the subscan axis from the first scan-bar homing reference;
b) performing a prescan or an image scan of an image by moving the scan bar along the subscan axis from the first scan-bar homing reference in relation to the image; and
c) performing a prescan or an image scan of the image or of an additional image by moving the scan bar along the subscan axis from the second scan-bar homing reference in relation to the image or the additional image.

11. A method for scanning an image comprising the steps of:
a) obtaining a scanner including a subscan axis, including a scan bar having a plurality of sensor elements, including a first scan-bar homing reference and including a second scan-bar homing reference spaced apart along the subscan axis from the first scan-bar homing reference;
b) performing a plurality of prescans of the image by alternately moving the scan bar in relation to the image along the subscan axis from the first scan-bar homing reference to the second scan-bar homing reference for each odd numbered prescan of the plurality of prescans and from the second scan-bar homing reference to the first scan-bar homing reference for each even numbered prescan of the plurality of prescans; and
c) after step b), image scanning the image by moving the scan bar in relation to the image along the subscan axis.

12. The method of claim 11 also including the step of establishing a position reference for the scan bar each time before the scan bar is moved from each of the first and second scan-bar homing references.

13. The method of claim 12 wherein the first scan-bar homing reference is a first scan-bar homing and sensor-element calibration reference, and also including, before step b); the step of calibrating the plurality of sensor elements from a scan of the first scan-bar homing reference by the scan bar.

14. The method of claim 13 wherein the step of calibrating comprises using a calibration reference selected from a group consisting of a white calibration reference, a black calibration reference, a gray calibration reference and a calibration reference that is a combination of the foregoing calibration references.

15. The method of claim 11 also including after step c), the step of moving the scan bar along the subscan axis to the closer of the first and second scan-bar homing references.

16. The method of claim 11 wherein the scanner is a component of a printing system.

17. A method for scanning an image comprising the steps of:
a) obtaining a scanner including a subscan axis, including a scan bar having a plurality of sensor elements, including a first scan-bar homing reference and including a second scan-bar homing reference spaced apart along the subscan axis from the first scan-bar homing reference;
b) disposing the scan bar about the first scan-bar homing reference;
c) after step b), performing a first prescan of the image by moving the scan bar from the first scan-bar homing reference to the second scan-bar homing reference in relation to the image along the subscan axis; and
d) after step c), performing a second prescan of the image by moving the scan bar from the second scan-bar homing reference to the first scan-bar homing reference in relation to the image along the subscan axis.

18. The method of claim 17 also including the step of establishing a position reference for the scan bar each time before the scan bar is moved from each of the first and second scan-bar homing references.

19. The method of claim 18 wherein the first scan-bar homing reference is a first scan-bar homing and sensor-element-calibration reference, and also including, between steps b) and c), the step of calibrating the plurality of sensor elements from a scan of the first scan-bar homing reference by the scan bar.

20. The method of claim 19 wherein the step of calibrating comprises using a calibration reference selected from a group consisting of a white calibration reference, a black calibration reference, a gray calibration reference and a calibration reference that is a combination of the foregoing calibration references.

21. The method of claim 17 wherein the scanner is a component of a printing system.

22. A method for scanning images comprising the steps of:
a) obtaining a scanner including a subscan axis, including a scan bar having a plurality of sensor elements, including a first scan-bar homing reference and including a second scan-bar homing reference spaced apart along the subscan axis from the first scan-bar homing reference;
b) disposing the scan bar about the first scan-bar homing reference;
c) prescanning a first image by moving the scan bar from the first scan-bar homing reference to the second scan-bar homing reference in relation to the image along the subscan axis;
d) after step c), image scanning the first image by moving the scan bar from the second scan-bar homing reference toward the first scan-bar homing reference in relation to the image along the subscan axis;
e) after step d), moving the scan bar to the second scan-bar homing reference, wherein the second scan-bar homing reference is the closer of the first and second scan-bar homing references to the scan bar at the completion of step d);
f) after step e), prescanning a second image, which is different from the first image, by moving the scan bar from the second scan-bar homing reference to the first scan-bar homing reference in relation to the image along the subscan axis; and
g) after step f), image scanning the second image by moving the scan bar from the first scan-bar homing reference toward the second scan-bar homing reference in relation to the image along the subscan axis.

23. The method of claim 22 also including the step of establishing a position reference for the scan bar each time before the scan bar is moved from each of the first and second scan-bar homing references.

24. The method of claim 23 wherein the first scan-bar homing reference is a first scan-bar homing and sensor-element-calibration reference, and also including, between steps b) and c), the step of calibrating the plurality of sensor elements from a scan of the first scan-bar homing reference by the scan bar.

25. The method of claim 24 wherein the second scan-bar homing reference is a second scan-bar homing and sensor-element-calibration reference, and also including, between steps e) and f), the step of calibrating the plurality of sensor elements from a scan of the second scan-bar homing reference by the scan bar.

26. The method of claim 25 wherein the steps of calibrating from a scan the first and second scan-bar homing references further comprises using a calibration reference selected from a group consisting of a white calibration reference, a black calibration reference, a gray calibration reference and a calibration reference that is a combination of the foregoing calibration references.

27. The method of claim 22 wherein the scanner is a component of a printing system.

28. A method for scanning images comprising the steps of:
a) obtaining a scanner including a subscan axis, including a scan bar having a plurality of sensor elements, including a first scan-bar homing reference and including a second scan-bar homing reference spaced apart along the subscan axis from the first scan-bar homing reference;
b) establishing a position reference for the scan bar including disposing the scan bar about the first scan-bar homing reference;
c) after step b), image scanning the first image by moving the scan bar from the first scan-bar homing reference toward the second scan-bar homing reference in relation to the image along the subscan axis;
d) after step c), establishing an updated position reference for the scan bar including disposing the scan bar about the second scan-bar homing reference; and
e) after step d), image scanning a second image, which is different from the first image, by moving the scan bar from the second scan-bar homing reference toward the first scan-bar homing reference in relation to the image along the subscan axis.

29. The method of claim 28 wherein the first scan-bar homing reference is a first scan-bar homing and sensor-element-calibration reference and/or the second scan-bar homing reference is a second scan-bar homing and sensor-element-calibration reference, and also including, between steps b) and c), the step of calibrating the plurality of sensor elements from a scan of the first scan-bar homing reference by the scan bar and/or, between steps d) and e), the step of calibrating the plurality of sensor elements from a scan of the second scan-bar homing reference by the scan bar.

30. The method of claim 29 wherein the steps of calibrating from a scan the first and second scan-bar homing references further comprises using a calibration reference selected from a group consisting of a white calibration reference, a black calibration reference, a gray calibration reference and a calibration reference that is a combination of the foregoing calibration references.

31. A method for scanning and printing an image comprising the steps of:
a) obtaining a scanner including a subscan axis, including a scan bar having a plurality of sensor elements, including a first scan-bar homing reference and including a second scan-bar homing reference spaced apart along the subscan axis from the first scan-bar homing reference;
b) establishing a position reference for the scan bar including disposing the scan bar about the first scan-bar homing reference;
c) after step b), performing a first image scan of the image by moving the scan bar from the first scan-bar homing reference toward the second scan-bar homing reference in relation to the image along the subscan axis;
d) after step c), printing a copy of the first image scan of the image;
e) after step d), establishing an updated position reference for the scan bar including disposing the scan bar about the second scan-bar homing reference;
f) after step e), performing a second image scan of the image by moving the scan bar from the second scan-bar homing reference toward the first scan-bar homing reference in relation to the image along the subscan axis; and
g) after step f), printing a copy of the second image scan of the image.

32. The method of claim 30 wherein the first scan-bar homing reference is a first scan-bar homing and sensor-element-calibration reference, and also including, between steps b) and c), the step of calibrating the plurality of sensor elements from a scan of the first scan-bar homing reference by the scan bar.

33. The method of claim 32 wherein the step of calibrating from a scan the first can-bar homing reference further comprises using a calibration reference selected from a group consisting of a white calibration reference, a black calibration reference, a gray calibration reference and a calibration reference that is a combination of the foregoing calibration references.
